(19) United States
(12) Patent Application Publication
(10) Pub. No.: US 2003/0097257 A1
(43) Pub. Date: May 22, 2003

(54) Sound signal process method, sound signal processing apparatus and speech recognizer

(76) Inventors: Tadashi Amada, Yokohama-shi (JP); Takanori Yamamoto, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/301,663

(22) Filed: Nov. 22, 2002

(30) Foreign Application Priority Data
Nov. 22, 2001 (JP) 2001-356880
Nov. 18, 2002 (JP) 2002-333118

(51) Int. Cl. G10L 11/06

(52) U.S. Cl. 704/208

(57) ABSTRACT

A sound signal processing method includes emphasizing a first sound signal based on a plurality of sound signals produced by a plurality of microphones arranged at intervals, determining a frequency by an arrival direction of a second sound signal other than the first sound signal and the interval between the microphones, and removing a frequency band including the frequency determined, from the first sound signal emphasized.

### CROSS-REFERENCE TO RELATED APPLICATIONS

This application is based upon and claims the benefit of priority from the prior Japanese Patent Application No. 2001-356880, filed Nov. 22, 2001, the entire contents of which are incorporated herein by reference.

### BACKGROUND OF THE INVENTION

1. Field of the Invention

In an electronic apparatus used in environments such as for driving home appliances, or in a car, it may not always be appropriate to operate a button or a switch by hand. For this reason, products operable by speech has been developed.

2. Description of the Related Art

However, there are many sound components in speech, thus accurate decision processes are often required for good speech recognition. Therefore, when performing actual speech recognition in a real environment, it is greatly affected by ambient noise. In a car, for example, the sound caused by the vehicle, such as from the engine, wind, car audio, or from other cars is noise. This noise is mixed in with the voice of the speaker, when input into speech recognition equipment, and lowers the accuracy of speech recognition.

In a microphone array that uses a microphone array technique for suppressing noise, speech input from a plurality of microphones is subjected to signal processing, to suppress noise and emphasize speech signal components. The speech recognition accuracy is improved by inputting this emphasized signal to the speech recognition apparatus.

Microphone arrays are broadly classified into delay sum arrays and adaptive type arrays. This is disclosed in “Sound System and Digital Processing” chapter 7, Institute of Electronics, Information and Communication Engineers, 1995”.

The delay sum array delays signals Sn(t) (n=1 . . . N) provided by N microphones by a time shift amount determined by the arrival direction of target speech and the alignment interval of microphones, and adds the delayed signals. In other words, an emphasized speech signal Se (t) is expressed by the following equation:

$$Se ( t ) = {{\sum }^{N}}_{n = 1} Sn ( t + n τ ) \qquad ( 1 )$$

where n is the interval between the microphones. The mechanism of the delay sum array uses the principle of superposition of phases. A target signal is emphasized by superimposing the in-phase components of the sound signals from the microphones. The phases of noise signals coming from a direction different from that of the target signal deviate from one another, resulting in weakening of the noise signals. The delay sum array is simple in structure, and relatively cheap, but is low in noise reduction performance.

The adaptive model array is a microphone array capable of adaptively changing the directional characteristic with respect to an input acoustic signal. A Griffiths-Jim type array (GJGSC) is used as the adaptive type array. This is described in an article “L. J. Griffiths and C. W. Jim, ‘An Alternative Approach to Linearly Constrained Adaptive Beamforming’ IEEE Trans. Antennas & Propagation, Vol. AP-30, No. 1, Jan., 1982.” GJGSC emphasizes a target speech similarly to the delay sum array and outputs it as a main signal, and further generate a sub-signal from which the target speech is removed. The main signal contains many noise components that are not completely erased yet. The sub-signal is a signal having correlation with the noise components included in the main signal. GJGSC uses a method for removing the noise components remained in the main signal, using the sub-signal and adaptive filter. The adaptive type array has high noise reduction efficiency, but has a tendency to increase in computation cost generally in comparison with the delay sum array.

When using the microphone array, neither the delay type array nor the adaptive type array produces any noise suppression effect based on the phase difference, under certain conditions. In the prior art, a method for making a microphone interval of each microphone array small has been taken in order to reduce aliasing. If the arrangement interval between the microphones is narrowed, the wavelength of noise which causes aliasing shortens.

Assuming that the condition that this aliasing occurs is a microphone interval corresponding to the frequency which is higher than a frequency band used for speech recognition, when the microphone interval is made small, the effect due to aliasing can be removed. However, when the microphone interval is narrowed, the difference between the distances that the noise signal arrives at the microphones get smaller, resulting in reducing noise reduction efficiency.

An object of the present invention is to provide a method for processing a sound signal without affect of aliasing, a sound signal processing apparatus therefor, and an speech recognizer provided with the same.

### BRIEF SUMMARY OF THE INVENTION

According to an aspect of the invention, there is provided a sound signal processing method comprising emphasizing a first sound signal based on a plurality of sound signals produced by a plurality of microphones arranged at intervals, determining a frequency by means of an arrival direction of a second sound signal other than the first sound signal and the intervals between the microphones, and removing a frequency band including the frequency determined, from the first sound signal emphasized.

According to another aspect of the invention, there is provided a sound signal processing apparatus comprising a microphone array including a plurality of microphones arranged at intervals and producing a plurality of sound signals, an emphasis unit configured to emphasize a first sound signal based on the plurality of sound signals, a frequency determination unit configured to determine a frequency by means of an arrival direction of a second sound signal other than the first sound signal and the intervals between the microphones, and a frequency band removing unit configured to remove a frequency band including the frequency determined, from the first sound signal emphasized.

### BRIEF DESCRIPTION OF THE SEVERAL VIEWS OF THE DRAWING

FIG. 1 shows a block circuit diagram of a speech recognition apparatus according to the first embodiment of the present invention;

FIG. 2 shows a state matching phases of sound signals;

FIGS. 3A and 3B show a state removing a frequency band form a sound signal;

FIG. 4 is a diagram indicating a process when a speaker is in a diagonal direction with respect to a microphone array;

FIG. 5 shows a block circuit of a speech recognition apparatus according to the second embodiment of the present invention;

FIG. 6 shows a block circuit of a speech recognition apparatus according to the third embodiment of the present invention;

FIGS. 7A and 7B show a state interpolating the frequency of a sound signal; and

FIG. 8 shows a block circuit of a speech recognition apparatus according to the fourth embodiment of the present invention.

### DETAILED DESCRIPTION OF THE INVENTION

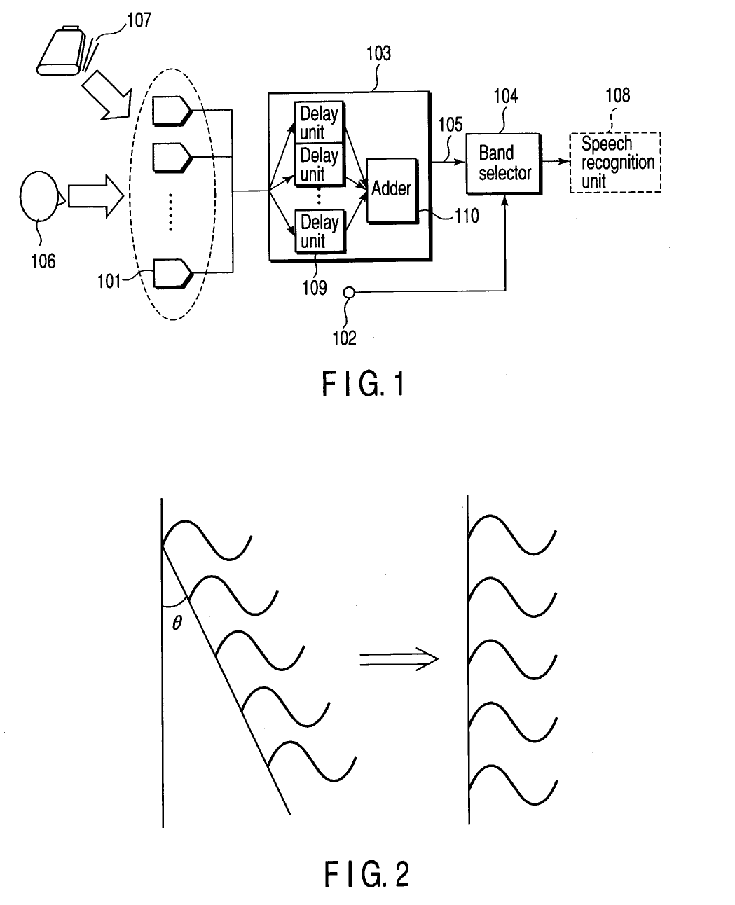

FIG. 1 shows a block circuit of a speech recognition apparatus according to the first embodiment of the present invention.

The speech of a speaker 106 is picked up by microphones 101. The microphones 101 are arranged in an array to form a microphone array. The speech signal provided by each microphone 101 is subjected to a delay process or an emphasis process by a delay unit 109 and an adder 110 in a beamformer 103. The beamformer 103 outputs a sound signal in which the target signal from the speaker 106 is emphasized. This sound signal 105 is input to a band selector 104 which receives information 102 regarding a noise arrival direction.

The band selector 104 determines a frequency causing aliasing on the basis of the noise arrival direction information 102, and outputs a sound signal obtained by eliminating signal components of the frequency band corresponding to the frequency causing aliasing from the input sound signal 105 to a speech recognition unit 108.

A process routine of the present embodiment is described in detail hereinafter. The sound signal, which is a mixture of target speech and noise, is input to the microphones 101. The microphones 101 are arranged in a line at equal intervals d. The target speech arrives at the front of the array of the microphones. Suppose that noise arrives at an angle with respect to the microphone array. The angle of arrival of noise with respect to the arrival direction of the target speech is θ. The noise is removed from the speech input to the microphones 101 by the beamformer 103 according to the microphone array technique described above, and the target speech signal is emphasized. The beamformer 103 can take various configurations. A beamformer comprising a delay sum array will now be described as an example.

When the signal input to each microphone 101 is Sn (t) (n=1 . . . N), the output Se(t) of the delay sum array is expressed by the equation (1):

$$Se ( t ) = {{\sum }^{N}}_{n = 1} Sn ( t + n τ ) \qquad ( 1 )$$

When the target speech arrives at the front of the microphone array, a time shift amount τ used for adding outputs of the microphones 101 is 0. At this time, the noise arriving at an angle 0 with respect to the microphone array indicates a different distance with respect to each of the microphones, so that a phase difference occurs between noise signals picked up by the microphones. If the noise signals having a phase difference are added to one another, the noise is not emphasized. In contrast, if the target speech signals which are in phase with τ=0 are added to one another the target speech is emphasized. Then, the level difference between the noise signal and the target signal increases substantially. As a result, the noise is suppressed and the target speech is emphasized.

However, when the distance difference l expressed by the following equation (2) is integer times the wave length λ, the effect described above is not obtained.

l=dsin (θ) (2)

Thus,

nλ=dsin (θ) (3)

where n expresses an arbitrary integer value. In the sound wave having the wave length λ, the deviation of phase exactly coincides in a cycle of n times as shown in FIG. 2, and the sound wave is emphasized on the same principle that the target signal is emphasized. This phenomenon is referred to as aliasing.

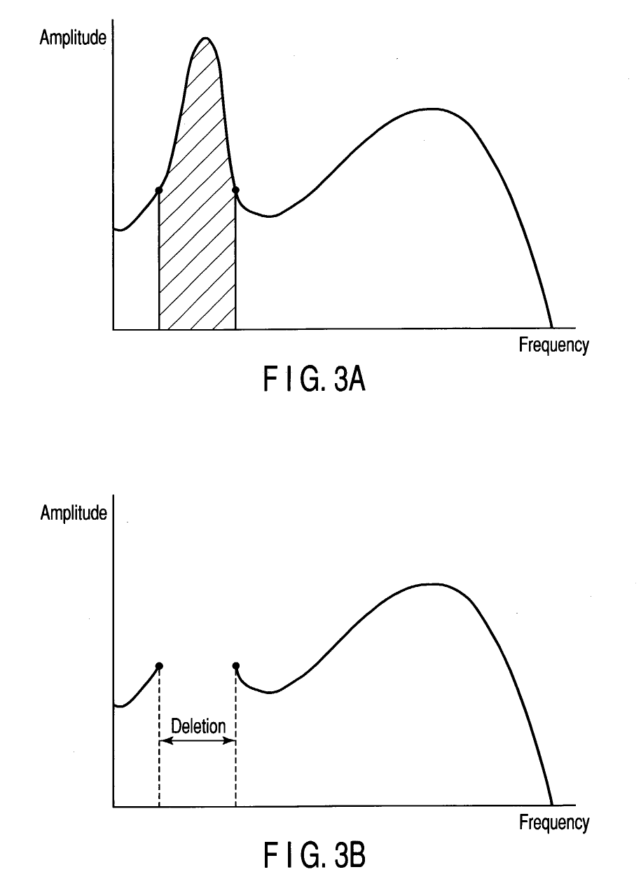

The band selector 104 calculates a frequency causing the aliasing of the sound signal input to the band selector 104 from the beamformer 103 as shown by a shaded area in FIG. 3A from noise arrival direction information given by a noise arrival direction information terminal 102, for example, an incidence angle with respect to a direction of the microphone array. Further, the band selector removes the band including the frequency calculated as shown in FIG. 3B from the sound signal input by the beamformer 103, using the band elimination filter circuit whose removal frequency is changeable.

The band selector 104 is supplied with not only the arrival direction but also information used for computing influence of the aliasing such as cross spectrum of a signal received by the microphone, for example, as the noise arrival direction information 102. The band selector 104 determines the band to be eliminated on the basis of the information.

An example of a method of computing a frequency causing aliasing will be described hereinafter.

If d (an interval between the microphones)=10 cm and θ (the angle with respect to the microphone array)=30°, for example, nλ=5 (cm) is obtained by the equation (3). In other words, λ=5/n (cm). The frequency f is expressed in 6.8 n (kHz), if the speed of sound is set to 340 m/s. Furthermore, if the beamformer 103 samples the speech signal by a sampling frequency of 16 kHz, the frequency band as a sampling value is a frequency band to 8 kHz. If the integer value n is 1, the frequency f causing aliasing is calculated as 6.8 (kHz). The frequency of 6.8 (kHz) obtained is in a range of the upper limited frequency 8(kHz) obtained by sampling.

In other words, in this example, the noise containing frequency components of 6.8 (kHz) is output along with the target signal from the beamformer 103 without being suppressed. The frequency components of 6.8 (kHz) mixed in the output signal without being suppressed effect the speech recognition process and so on in the rear stage. Thus, the beamformer 103 removes the frequency or the frequency band including this frequency from the output signal. The degree to which the bandwidth should be removed greatly depends upon the performance of a filter. Since the frequency is uniquely determined by the arrival direction of noise in view of the nature of aliasing, it is desirable for keeping other effective components that the removal range is determined to a required minimum range not to affect the speech recognition unit of the rear stage.

Persons may unnaturally hear the speech signal from which such a specific frequency band is removed. Analyzing special features of the waveform of a given sound signal or frequency components included therein performs the current speech recognition. Alternatively, the speech recognition may be performed using the representative value of each of bands obtained by non-uniformly dividing a bandwidth. These methods may have acoustical problems. However, the method for analyzing speech only using the frequency band that noise is reduced enough is higher in recognition accuracy than that using the sound signal including noises.

The operation when the speaker 106 is on the place aside from the front of microphone array will be described hereinafter.

The beamformer 103 adjusts the delay time of the sound signal of each of the microphones so that the difference between times at which the target speech uttered by the speaker 106 arrives at the microphones 101, respectively, disappears. The above adjustment is to subject each of the sound signals provided from the microphones 101 to a delay process so that the phases of the target speech signals included in the sound signals provided by the microphones 101 coincide to one another.

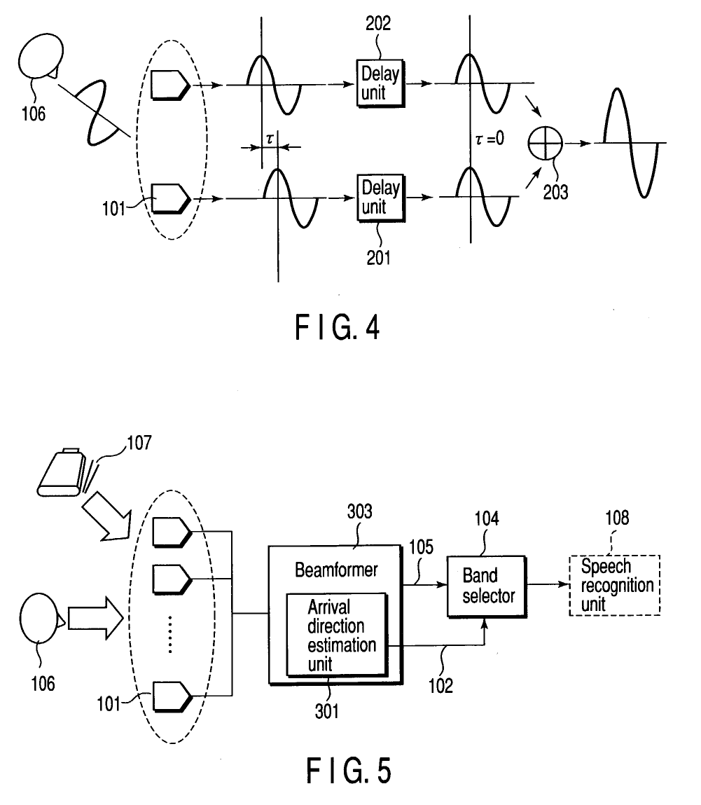

This condition is shown in FIG. 4. When the microphones 101 pick up the speech of the speaker 106, a lag time τ occurs between the speech signals provided from the microphones, because distances from the speaker to the microphones are different. The delay units 201 and 202 adjust the phases of the signals to make a status (τ=0) that no time lag occurs between two target signals. The adder 203 adds these speech signals to generate a sound signal including the emphasized target signal.

By performing the above process, the speech from the speaker that locates aside from the front of the microphone array can be subjected to the same processing as the sound signal processing subjecting to the target speech from the front of the microphone array. According to this method, even if the speaker locates aside from the front of the microphone array, the present invention is applicable to such case.

The second embodiment of the present invention will be described. FIG. 5 shows a sound signal processing apparatus of the second embodiment. The second embodiment differs from the first embodiment in a structure wherein an arrival direction estimation unit 301 estimates an arrival direction of noise, and inputs an evaluation result to a band selector 104. The other structure is same as the first embodiment. A unit for specifying an arrival direction of noise is necessary for specifying a frequency causing aliasing. In the present invention, the arrival direction estimation unit 301 performs the specification of the frequency.

The noise arrival direction can be comparatively easily estimated when the Griffiths Jim type microphone array is used which is a representative of the adaptive type array (GJGSC). Generally the response characteristic of the adaptive type array suddenly falls in the noise arrival direction. This phenomenon is called occurrence of dip. The arrival direction estimation unit 301 estimates the direction that this dip occurs as the noise arrival direction. There is, as a method for searching the direction that the dip occurs, a method for obtaining an impulse response of a transfer function from an input to the microphone to an output of the beamformer every microphone, in the status that the adaptive operation of the microphone array converges. The correlation function between the microphones is computed from the impulse response and the time difference that the correlation function indicates the minimum value is computed. Furthermore, the angle corresponding to the time difference is computed from the time difference. This angle can be estimated as the noise arrival direction.

The noise arrival direction information 102 estimated is input to the band selector 104. The band selector 104 computes a frequency band causing aliasing corresponding to the angle by a known method. The components of the computed frequency band are removed from the sound information provided by the beamformer 303, by the band elimination filter circuit whose removal frequency is changeable.

According to the above method, even if the noise arrival direction is unknown, it is possible to get the sound signal that is not affected by aliasing.

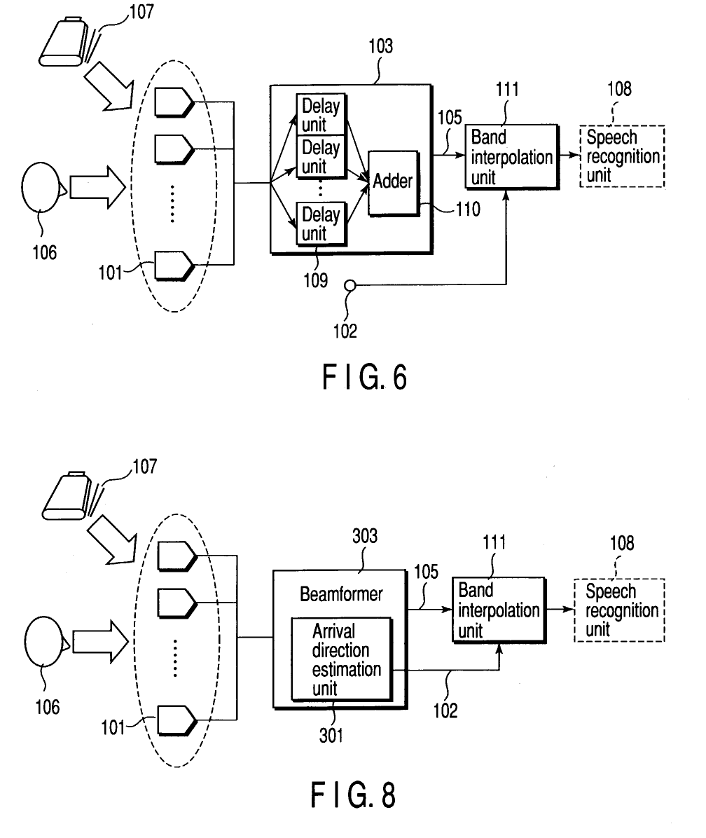

The third embodiment of the present invention will be described in conjunction with FIG. 6. This embodiment is similar to the first embodiment except for using a frequency interpolating unit 109 instead of the band selector 104.

The first and second embodiments eliminate the frequency band in which the aliasing occurs. In this case, a listener may feel odd in hearing tone really. Further, when the speech recognition unit 108 on a rear stage does not premise that a specific band is eliminated, the mismatch in the eliminated band becomes a factor decreasing recognition accuracy greatly. The present embodiment solves the above problem by using a method of not eliminating the band where the aliasing occurs but interpolating the band.

The interpolating method may be a method of using, for example, a weighting linear sum of components of a peripheral band.

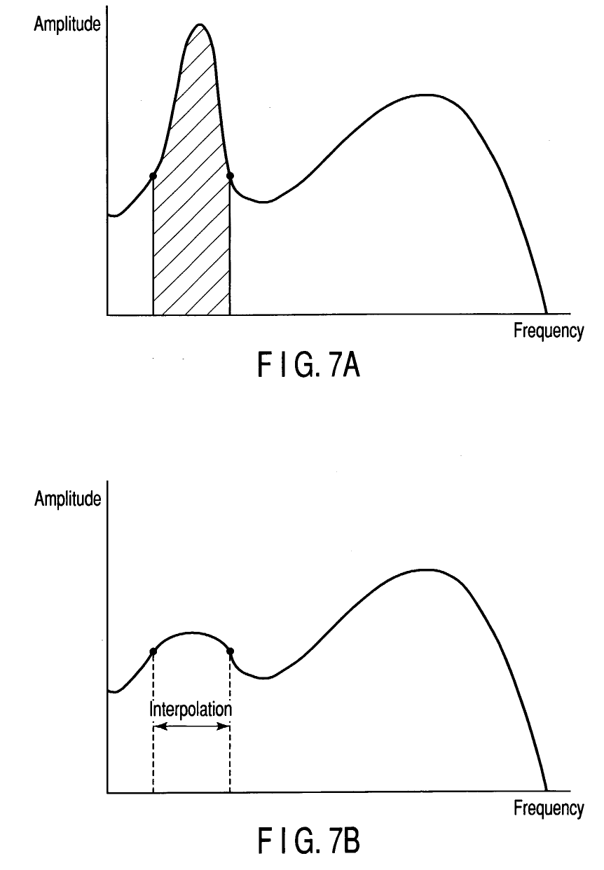

The state interpolating the frequency band of a sound signal where aliasing occurs will be described referring to FIGS. 7A and 7B.

FIG. 7A shows a sound signal input to a band interpolating unit 111 from a beamformer 103. The band shown by a shaded area is the band that aliasing occurs. The frequency band is interpolated by the band interpolating unit 111 using the above interpolation method as shown in FIG. 7B. The spectrum of the sound signal output from frequency interpolating unit 109 by the interpolation process is continuous, resulting in producing a signal that is good acoustically.

The fourth embodiment of the present invention will be described in conjunction with FIG. 8.

The present embodiment is similar to the second embodiment except for using a frequency interpolating unit 109 instead of the band selector 104 of the second embodiment. The second embodiment eliminates the frequency band where aliasing occurs, so that a listener may feel odd in hearing tone really. Further, when the speech recognition unit 108 on a rear stage does not premise that a specific band is eliminated, the mismatch in the eliminated band becomes a factor decreasing recognition accuracy greatly.

The present embodiment solves the above problem by using a method of not eliminating the band where the aliasing occurs but interpolating the band as with the third embodiment. The interpolating method may be a method of using, for example, a weighting linear sum of components of a peripheral band. The spectrum of the sound signal output from frequency interpolating unit 109 is continuous by the interpolation process, resulting in producing a signal that is good acoustically.

It is conceivable that a plurality of noises comes from different directions. In this case, frequencies causing aliasing in correspondence with the noise arrival directions, respectively, are calculated. The frequencies and frequency bands including the frequencies are removed from the sound information according to the above method.

In the embodiments, the band selector 104 switches between a route to make band removal function when noise is mixed in the speech signal and a route to transfer the sound signal from the beamformer 103 directly to the speech recognition unit 108 when no noise is mixed therein.

When the sound signal output from the band selector 104 is input to the speech recognition unit 108, the speech recognition unit 108 performs speech recognition based on the sound signal from which the frequency or the frequency band is removed or which is interpolated.

The band selector 104 is not only supplied directly with the arrival direction as the noise arrival direction information 102, but also supplied with information by which influence of the aliasing such as cross spectrum of a signal of a sound received by a microphone, for example, can be computed. The band selector 104 may determine the band to be eliminated on the basis of the information.

By removing or interpolating a frequency causing aliasing which is determined by an arrival direction of noise or a frequency band including the frequency from a sound signal provided from a microphone array, a sound signal suitable for a speech signal subjected to speech recognition can be produced. In the above embodiments, the microphones may be arranged in a line at different intervals.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sound signal processing method comprising:
emphasizing a first sound signal based on a plurality of sound signals produced by a plurality of microphones arranged at intervals;
determining a frequency by means of an arrival direction of a second sound signal other than the first sound signal and the intervals between the microphones; and
removing a frequency band including the frequency determined, from the first sound signal emphasized.

2. The method according to claim 1, which includes subjecting the sound signals to a delay process to superimpose sound signal components in phase substantially, the sound signal components being included in the sound signals and corresponding to the first sound signal.

3. The method according to claim 1, which includes detecting degradation of a response characteristic of an array of the plurality of microphones based on the plurality of sound signals, and determining a direction that the degradation of the response characteristic occurs as the arrival direction of the second sound signal.

4. The method according to claim 3, which the array of the plurality of microphones comprises a Griffiths Jim type microphone array.

5. The method according to claim 1, which includes adding the plurality of sound signals to emphasize the first sound signal and decay the second sound signal.

6. The method according to claim 1, wherein determining the frequency includes computing a frequency occurring aliasing which emphasizes the second sound signal as well as the first sound signal, using the arrival direction of the second sound signal and the intervals between the microphones.

7. The method according to claim 1, wherein the first sound signal includes a speech signal, and the second sound signal includes a noise signal.

8. A sound signal processing method comprising:
emphasizing a first sound signal based on a plurality of sound signals produced by a plurality of microphones arranged at intervals;
determining a frequency by means of an arrival direction of a second sound signal other than the first sound signal and the intervals between the microphones; and
interpolating a frequency band including the frequency determined, based on the first sound signal emphasized.

9. A sound signal processing apparatus comprising:
a microphone array including a plurality of microphones arranged at intervals and producing a plurality of sound signals;
an emphasis unit configured to emphasize a first sound signal based on the plurality of sound signals;
a frequency determination unit configured to determine a frequency by means of an arrival direction of a second sound signal other than the first sound signal and the intervals between the microphones; and
a frequency band removing unit configured to remove a frequency band including the frequency determined, from the first sound signal emphasized.

10. The apparatus according to claim 9, wherein the emphasis unit includes a delay unit configured to subject the sound signals to a delay process to superimpose sound signal components in phase substantially, the sound signal components being included in the sound signals and corresponding to the first sound signal.

11. The apparatus according to claim 9, which the frequency determination unit includes an arrival direction specification unit configured to compute an arrival direction of the second sound signal which differs from that of the first sound signal, from the sound signals provided from the plurality of microphones.

12. The apparatus according to claim 11, wherein the arrival direction specification unit includes an arrival direction detecting/determining unit configured to detect degradation of a response characteristic of the microphone array based on the plurality of sound signals and determine a direction that the degradation of the response characteristic occurs as the arrival direction of the second sound signal.

13. The apparatus according to claim 11, wherein the microphone array comprises a Griffiths Jim type microphone array.

14. The apparatus according to claim 9, wherein the emphasis unit includes an adder that adds the plurality of sound signals to emphasize the first sound signal and decay the second sound signal.

15. The apparatus according to claim 14, wherein the emphasis unit includes a delay unit configured to subject the sound signals to delay processing to make sound signals corresponding to the first sound signal in phase.

16. The apparatus according to claim 9, wherein the frequency determining unit includes a unit configured to compute a frequency occurring aliasing which emphasizes the second sound signal as well as the first sound signal, using the arrival direction of the second sound signal and the intervals between the microphones.

17. The method according to claim 9, wherein the first sound signal includes a speech signal, and the second sound signal includes a noise signal.

18. A sound signal processing apparatus comprising:
a microphone array including a plurality of microphones arranged at intervals and producing a plurality of sound signals;
an emphasis unit configured to emphasize a first sound signal based on the plurality of sound signals;
a frequency determination unit configured to determine a frequency by means of an arrival direction of a second sound signal other than the first sound signal and the intervals between the microphones; and
a frequency band interpolating unit configured to interpolate a frequency band including the frequency determined.

19. A sound signal processing apparatus comprising:
a microphone array including a plurality of microphones arranged at intervals and producing a plurality of sound signals including a speech signal;
a beamformer supplied with the sound signals to emphasize the speech signal and output an emphasized speech signal; and
a frequency band remover which determines a frequency by means of an arrival direction of a noise signal contained in the sound signals and the intervals between the microphones and removes a frequency band including the frequency determined, from the emphasized speech signal.

20. The apparatus according to claim 19, wherein the beamformer comprises a delay unit configured to subject the sound signals to delay processing to make speech signal components contained in the sound signals and corresponding to the speech signal in phase, and an adder which adds the sound signals subjected to the delay processing to output the emphasized speech signal.

21. A speech recognizer comprising the sound signal processing apparatus according to claim 19 and a speech recognition unit configured to subject the emphasized speech signal output from the sound signal processing apparatus to speech recognition.

22. A sound signal processing apparatus comprising:
a microphone array including a plurality of microphones arranged at intervals and producing a plurality of sound signals including a speech signal;
a beamformer supplied with the sound signals to emphasize the speech signal and output an emphasized speech signal; and
a frequency band interpolating unit which determines a frequency by means of an arrival direction of a noise signal contained in the sound signals and the intervals between the microphones and interpolate a frequency band including the frequency determined, based on the emphasized speech signal.
